(19) United States
(12) Patent Application Publication
(10) Pub. No.: US 2010/0227687 A1
(43) Pub. Date: Sep. 9, 2010

(54) RANDOM GENERATED DISPLAY ASSOCIATED WITH GAMING DEVICE

(75) Inventors: L. Donald Speer, II, San Diego, CA (US); W. Greg Shay, Las Vegas, NV (US); Kevin McIntosh, San Diego, CA (US); Donne Grable, San Diego, CA (US)

Correspondence Address: MARGER JOHNSON & MCCOLLOM, P.C., 210 SW MORRISON STREET, SUITE 400, PORTLAND, OR, 97204, US

(73) Assignee: VCAT, LLC, San Diego, CA (US)

(21) Appl. No.: 12/398,911

(22) Filed: Mar. 5, 2009

(51) Int. Cl. A63F 13/00

(52) U.S. Cl. 463/31

(57) ABSTRACT

Embodiments of the present invention are directed to a method and system for displaying a pattern associated with a gaming device to heighten the gaming interest of players or potential players. These methods and systems include displaying an initial pattern and altering the initial pattern as play on the gaming device progresses, or as pattern modifying signals are otherwise received. The displayed pattern may be presented on any display device, including but not limited to the game screen or on any screen or panel on a gaming device, in a secondary display device attached or detached from the gaming device or table game, or any other display applications used on or with a gaming device or table.

### RELATED APPLICATIONS

Commonly assigned U.S. Patent Applications:

Ser. No. ______, to L. Donald Speer II et al., filed concurrently herewith, for OUTCOME BASED DISPLAY OF GAMING RESULTS (Attorney Docket No. 9615-0003).

### FIELD OF THE INVENTION

This disclosure relates generally to gaming devices, and more particularly to gaming devices having a random generated display associated with the gaming device and methods of generating the randomly generated display for the gaming devices.

### BACKGROUND

With games of chance, gaming players often seek out certain games (including but not limited to slot machines, electronic table games, live action table games, internet games, lotteries, etc.) or game configurations (including but not limited to player positions, dealers, game devices such as card shoes, etc.) or change their behavior based on actual or perceived patterns or trends (collectively referred to as patterns herein) the players believe they see related to a game, a game configuration, or a player. The patterns that are likely to influence their behavior can be based on game or player outcomes and can be applicable to the game type, gaming device, game location, player position, game configuration, etc. These patterns can influence player behavior in many ways, including a decision to play or not, the game type and/or location of the game they choose to play, the wager amount, etc. Behavior influence is often times attributable to the player's belief that future outcomes are, or will be, more predictable based on actual or perceived patterns they believe they see.

In addition, player behavior can also be influenced by other “signs” that the player sees (and maybe only they can see) that make them believe that a certain game is lucky or not lucky, or that a certain pattern exists or is likely. A sign can simply be that a player believes in a lucky number, symbol, date, color etc. It can also involve their belief that someone or something else is lucky, such as another player, a dealer, a location, a device, etc., which becomes associated with the sign they see.

Currently, players may select a gaming machine to play by its theme, availability, and location or proximity to certain casino areas. When presented with a bank of similar games, all of which are available, a player may select a device based on how lucky he or she perceives the gaming device. For example, rumors exist that casinos often place higher paying machines at the edges of rows or banks so that the increase in winning outcomes is more visible to other players who may be influenced to play the game as well. Whether or not this rumor is true, it can affect a player's decision on which gaming device to choose. Other influencing factors may include the last game outcome shown on the gaming machine, how large the “cash-out” value of the last player was, the screen brightness, etc. For table games, players may select a certain table or position at a table based on other observations. For example, they may look to the attitude of other players at the table, the demeanor of the dealer, the positions open at the table, etc.

At some level, what the players are looking for are certain characteristics of the gaming device or other recognizable patterns that they have an association with. If a player has won in the past at a specific device or at the last seat or position at a table, they may feel that they should continue this pattern of choosing that device or position to increase their chances of continuing to win. The patterns they may be seeking can vary widely between players. Often times the patterns they are seeking are simple. For example, a player might try to determine what games or game configurations have been good for the player, or alternatively bad for the player and good for the “house” and associate these beliefs with patters or signs they see.

Thus, it is likely that player behavior and the decisions they make are, and can be further influenced by patterns or other signs the players believe they see and that the player experience will be enhanced or changed by creating a method and system of consolidating and presenting patterns or other signs to players as part of, or in conjunction with, the games they seek to play.

### BRIEF DESCRIPTION OF THE DRAWINGS

FIG. 1A is a functional block diagram that illustrates a gaming device according to embodiments of the invention.

FIG. 1B is an isometric view of the gaming device illustrated in FIG. 1A.

FIGS. 2A, 2B, and 2C are detail diagrams of exemplary types of gaming devices according to embodiments of the invention.

FIG. 3 is a functional block diagram of networked gaming devices according to embodiments of the invention.

FIG. 4 is a detail diagram of a gaming device having a pattern display according to embodiments of the invention.

FIGS. 5A and 5B are detail diagrams of displays showing exemplary types of pattern displays according to embodiments of the invention.

FIG. 6 is a detail diagram of a table gaming device having a pattern display according to embodiments of the invention.

FIGS. 7A and 7B are detail diagrams of exemplary types of displays for displaying patterns according to embodiments of the invention.

FIGS. 8A and 8B are flow diagrams illustrating methods of generating a pattern display according to embodiments of the invention.

FIG. 9 is a flow diagram illustrating methods of updating a pattern display according to embodiments of the invention.

FIG. 10 is a flow diagram illustrating methods of displaying a pattern display according to embodiments of the invention.

FIG. 11 is a flow diagram illustrating methods of altering a pattern display according to embodiments of the invention.

FIG. 12 is a flow diagram illustrating methods of altering a pattern display according to embodiments of the invention.

### DETAILED DESCRIPTION

As discussed above, a method and system for displaying a pattern associated with a gaming device is desirable to heighten the gaming interest of players or potential players. As will be discussed in detail below, this may include displaying an initial pattern and altering the initial pattern as play on the gaming device progresses, or as pattern modifying signals are otherwise received. The displayed pattern may be presented on any display device, including but not limited to the game screen or on any screen or panel on a gaming device, in a secondary display device attached or detached from the gaming device or table game, or any other display applications used on or with a gaming device or table.

In some embodiments, these patterns may be generated by randomly assigning or modifying marks to a pattern display at periodic intervals, at random, in response to a game event, or in response to another pattern modification signal. In other embodiments, patterns may be generated by randomly assigning a mark within a predetermined boundary or range within a pattern display in response to a game outcome or other game event. The predetermined boundary or range may include portions of a player selected or otherwise predetermined symbol that is modified by the pattern markings. Some of these embodiments further allow a player to manipulate the pattern display to alter the current pattern, change the type of pattern shown, reset the pattern, or view a historical progression of the pattern to its current state.

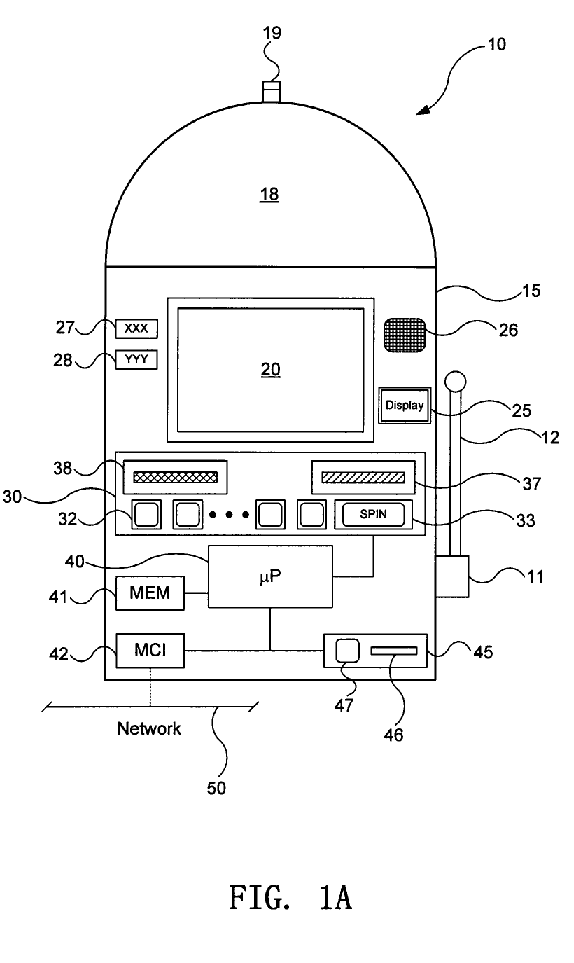

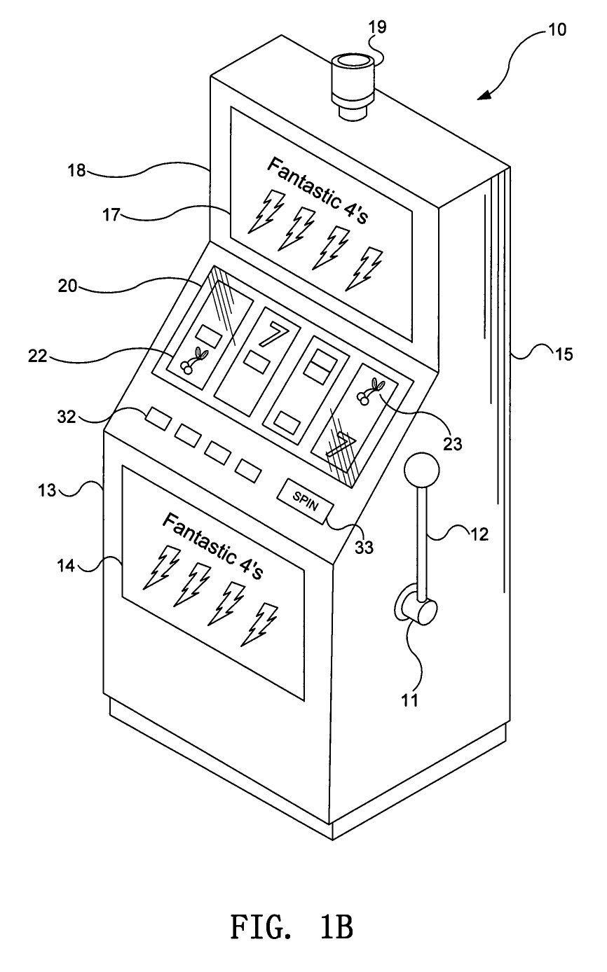

FIGS. 1A and 1B illustrate example gaming devices according to embodiments of the invention.

Referring to FIGS. 1A and 1B, a gaming device 10 is an electronic gaming machine. Although an electronic gaming machine or “slot” machine is illustrated, various other types of devices may be used to wager monetarily based credits on a game of chance in accordance with principles of the invention. The term “electronic gaming device” is meant to include various devices such as electromechanical spinning-reel type slot machines, video slot machines, and video poker machines, for instance. Other gaming devices may include computer-based gaming machines, wireless gaming devices, multi-player gaming stations, modified personal electronic gaming devices (such as cell phones), personal computers, server-based gaming terminals, lottery devices, and other similar devices. Although embodiments of the invention will work with all of the gaming types mentioned, for ease of illustration the present embodiments will be described in reference to the electronic gaming machine 10 shown in FIGS. 1A and 1B.

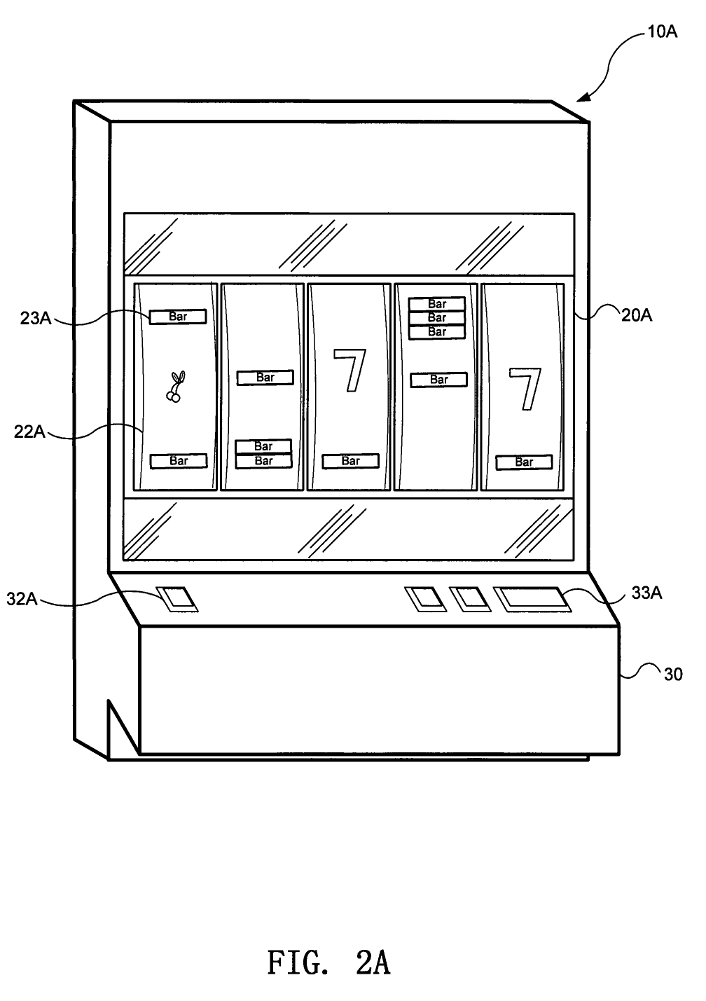

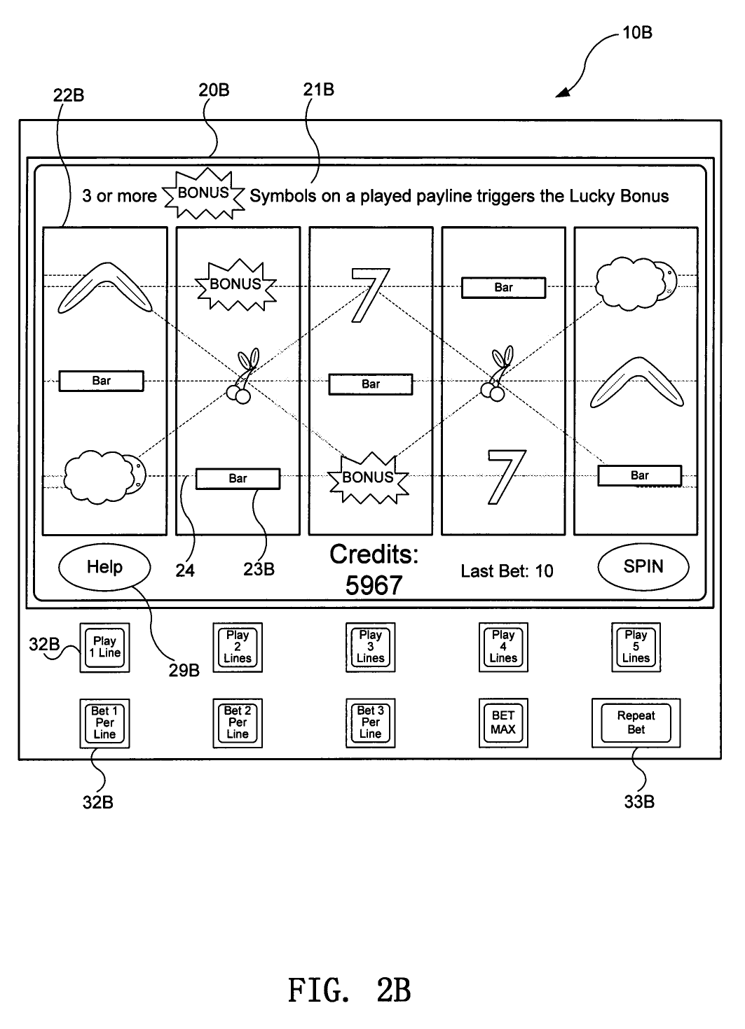

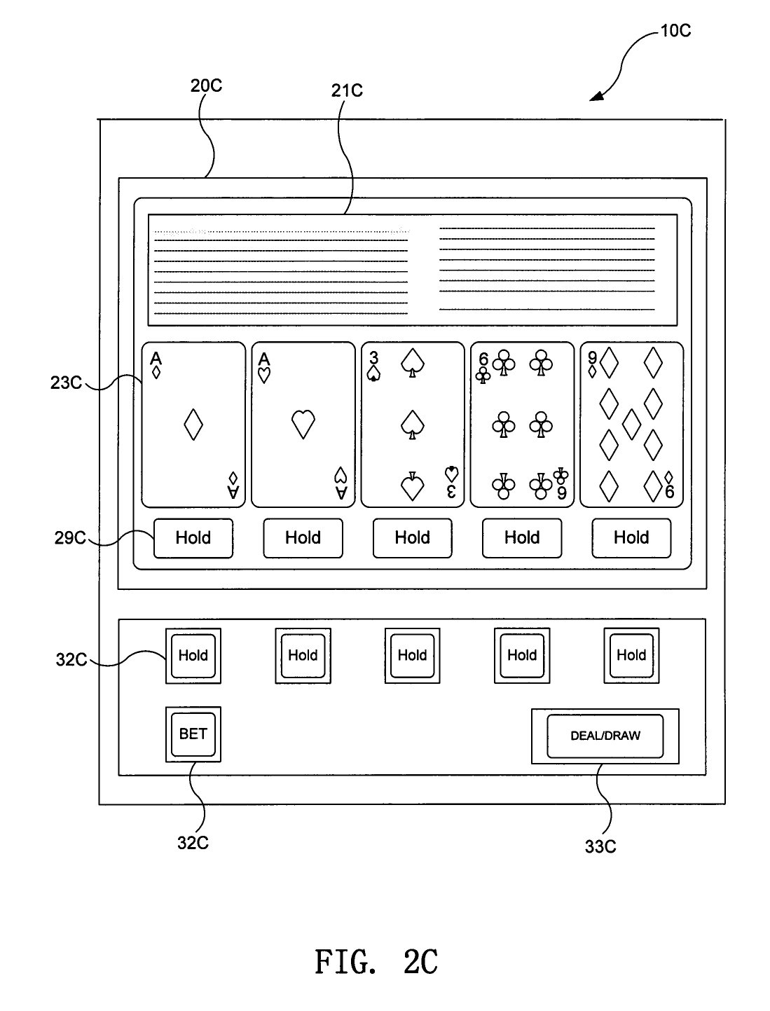

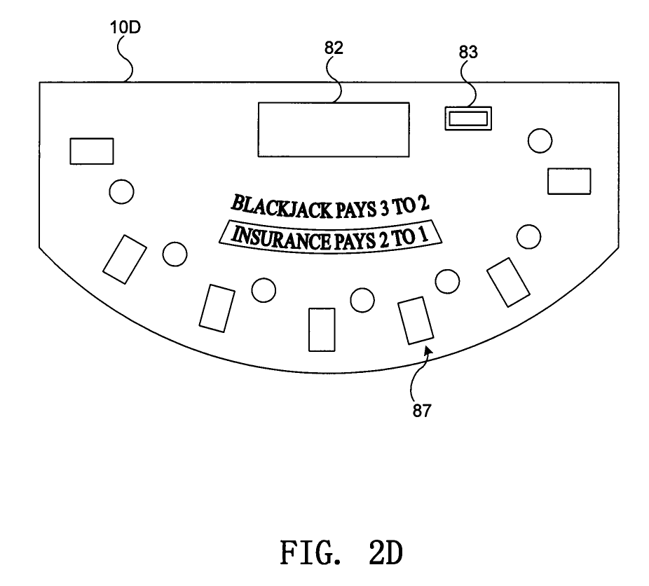

The gaming device 10 includes a cabinet 15 housing components to operate the gaming device 10. The cabinet 15 may include a gaming display 20, a base portion 13, a top box 18, and a player interface panel 30. The gaming display 20 may include mechanical spinning reels (FIG. 2A), a video display (FIGS. 2B and 2C), or a combination of both spinning reels and a video display (not shown). The gaming cabinet 15 may also include a credit meter 27 and a coin-in or bet meter 28. The credit meter 27 may indicate the total number of credits remaining on the gaming device 10 that are eligible to be wagered. In some embodiments, the credit meter 27 may reflect a monetary unit, such as dollars. However, it is often preferable to have the credit meter 27 reflect a number of ‘credits,’ rather than a monetary unit. The bet meter 28 may indicate the amount of credits to be wagered on a particular game. Thus, for each game, the player transfers the amount that he or she wants to wager from the credit meter 27 to the bet meter 28. In some embodiments, various other meters may be present, such as meters reflecting amounts won, amounts paid, or the like. In embodiments where the gaming display 20 is a video monitor, the information indicated on the credit meters may be shown on the gaming display itself 20 (FIG. 2B).

The base portion 13 may include a lighted panel 14, a coin return (not shown), and a gaming handle 12 operable on a partially rotating pivot joint 11. The game handle 12 is traditionally included on mechanical spinning-reel games, where the handle may be pulled toward a player to initiate the spinning of reels 22 after placement of a wager. The top box 18 may include a lighted panel 17, a video display (such as an LCD monitor), a mechanical bonus device (not shown), and a candle light indicator 19. The player interface panel 30 may include various devices so that a player can interact with the gaming device 10.

The player interface panel 30 may include one or more game buttons 32 that can be actuated by the player to cause the gaming device 10 to perform a specific action. For example, some of the game buttons 32 may cause the gaming device 10 to bet a credit to be wagered during the next game, change the number of lines being played on a multi-line game, cash out the credits remaining on the gaming device (as indicated on the credit meter 27), or request assistance from casino personnel, such as by lighting the candle 19. In addition, the player interface panel 30 may include one or more game actuating buttons 33. The game actuating buttons 33 may initiate a game with a pre-specified amount of credits. On some gaming devices 10 a “Max Bet” game actuating button 33 may be included that places the maximum credit wager on a game and initiates the game. The player interface panel 30 may further include a bill acceptor 37 and a ticket printer 38. The bill acceptor 37 may accept and validate paper money or previously printed tickets with a credit balance. The ticket printer 38 may print out tickets reflecting the balance of the credits that remain on the gaming device 10 when a player cashes out by pressing one of the game buttons 32 programmed to cause a ‘cashout.’ These tickets may be inserted into other gaming machines or redeemed at a cashier station or kiosk for cash.

The gaming device 10 may also include one or more speakers 26 to transmit auditory information or sounds to the player. The auditory information may include specific sounds associated with particular events that occur during game play on the gaming device 10. For example, a particularly festive sound may be played during a large win or when a bonus is triggered. The speakers 26 may also transmit “attract” sounds to entice nearby players when the game is not currently being played.

The gaming device 10 may further include a secondary display 25. This secondary display 25 may be a vacuum fluorescent display (VFD), a liquid crystal display (LCD), a cathode ray tube (CRT), a plasma screen, or the like. The secondary display 25 may show any combination of primary game information and ancillary information to the player. For example, the secondary display 25 may show player tracking information, secondary bonus information, advertisements, or player selectable game options.

The gaming device 10 may include a separate information window (not shown) dedicated to supplying any combination of information related to primary game play, secondary bonus information, player tracking information, secondary bonus information, advertisements or player selectable game options. This window may be fixed in size and location or may have its size and location vary temporally as communication needs change. One example of such a resizable window is International Game Technology's “service window.” Another example is Las Vegas Gaming Incorporated's retrofit technology which allows information to be placed over areas of the game or the secondary display screen at various times and in various situations.

The gaming device 10 includes a microprocessor 40 that controls operation of the gaming device 10. If the gaming device 10 is a standalone gaming device, the microprocessor 40 may control virtually all of the operations of the gaming devices and attached equipment, such as operating game logic stored in memory (not shown) as firmware, controlling the display 20 to represent the outcome of a game, communicating with the other peripheral devices (such as the bill acceptor 37), and orchestrating the lighting and sound emanating from the gaming device 10. In other embodiments where the gaming device 10 is coupled to a network 50, as described below, the microprocessor 40 may have different tasks depending on the setup and function of the gaming device. For example, the microprocessor 40 may be responsible for running the base game of the gaming device and executing instructions received over the network 50 from a bonus server or player tracking server. In a server-based gaming setup, the microprocessor 40 may act as a terminal to execute instructions from a remote server that is running game play on the gaming device.

The microprocessor 40 may be coupled to a machine communication interface (MCI) 42 that connects the gaming device 10 to a gaming network 50. The MCI 42 may be coupled to the microprocessor 40 through a serial connection, a parallel connection, an optical connection, or in some cases a wireless connection. The gaming device 10 may include memory 41 (MEM), such as a random access memory (RAM), coupled to the microprocessor 40 and which can be used to store gaming information, such as storing total coin-in statistics about a present or past gaming session, which can be communicated to a remote server or database through the MCI 42. The MCI 42 may also facilitate communication between the network 50 and the secondary display 25 or a player tracking unit 45 housed in the gaming cabinet 15.

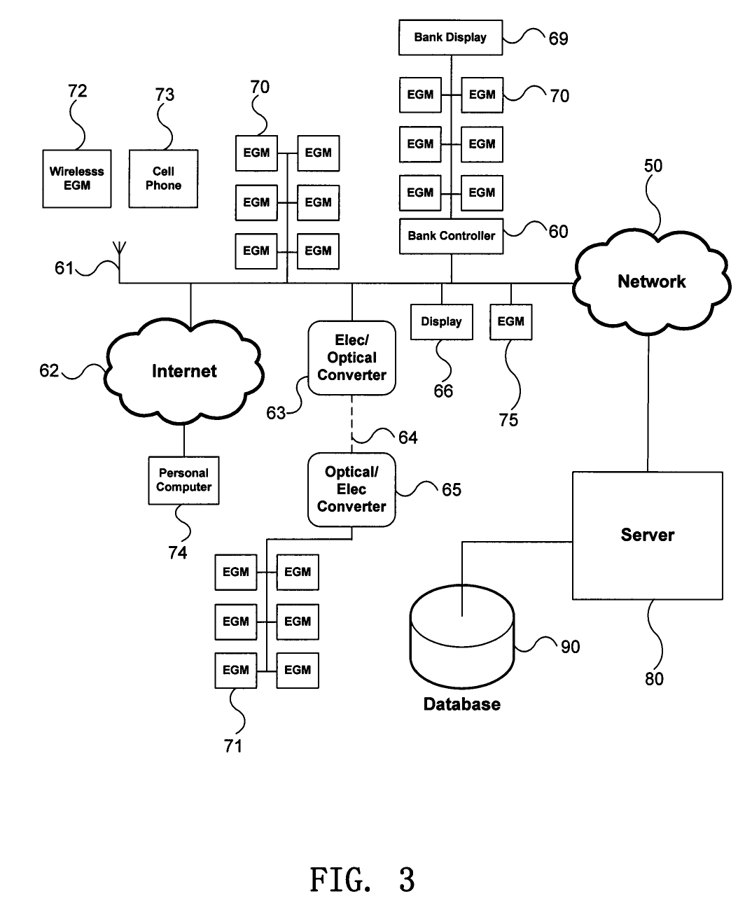

The player tracking unit 45 may include an identification device 46 and one or more buttons 47 associated with the player tracking unit 45. The identification device 46 serves to identify a player, by, for example, reading a player-tracking device, such as a player tracking card that is issued by the casino to individual players who choose to have such a card. The identification device 46 may instead, or additionally, identify players through other methods. Player tracking systems using player tracking cards and card readers 46 are known in the art. Briefly summarizing such a system, a player registers with the casino prior to commencing gaming. The casino issues a unique player-tracking card to the player and opens a corresponding player account that is stored on a server or host computer, described below with reference to FIG. 3. The player account may include the player's name and mailing address and other information of interest to the casino in connection with marketing efforts. Prior to playing one of the gaming devices in the casino, the player inserts the player tracking card into the identification device 46 thus permitting the casino to track player activity, such as amounts wagered, credits won, and rate of play.

To induce the player to use the card and be an identified player, the casino may award each player points proportional to the money or credits wagered by the player. Players typically accrue points at a rate related to the amount wagered, although other factors may cause the casino to award the player various amounts. The points may be displayed on the secondary display 25 or using other methods. In conventional player tracking systems, the player may take his or her card to a special desk in the casino where a casino employee scans the card to determine how many accrued points are in the player's account. The player may redeem points for selected merchandise, meals in casino restaurants, or the like, which each have assigned point values. In some player tracking systems, the player may use the secondary display 25 to access their player tracking account, such as to check a total number of points, redeem points for various services, make changes to their account, or download promotional credits to the gaming device 10. In other embodiments, the identification device 46 may read other identifying cards (such as driver licenses, credit cards, etc.) to identify a player and match them to a corresponding player tracking account. Although FIG. 1A shows the player tracking unit 45 with a card reader as the identification device 46, other embodiments may include a player tracking unit 45 with a biometric scanner, PIN code acceptor, or other methods of identifying a player to pair the player with their player tracking account.

During typical play on a gaming device 10, a player plays a game by placing a wager and then initiating a gaming session. The player may initially insert monetary bills or previously printed tickets with a credit value into the bill acceptor 37. The player may also put coins into a coin acceptor (not shown) or a credit, debit or casino account card into a card reader/authorizer (not shown). One of skill in the art will readily see that this invention is useful with all gambling devices, regardless of the manner in which wager value-input is accomplished.

The credit meter 27 displays the numeric credit value of the money inserted dependent on the denomination of the gaming device 10. That is, if the gaming device 10 is a nickel slot machine and a $20 bill inserted into the bill acceptor 37, the credit meter will reflect 400 credits or one credit for each nickel of the inserted twenty dollars. For gaming devices 10 that support multiple denominations, the credit meter 27 will reflect the amount of credits relative to the denomination selected. Thus, in the above example, if a penny denomination is selected after the $20 is inserted the credit meter will change from 400 credits to 2000 credits.

A wager may be placed by pushing one or more of the game buttons 32, which may be reflected on the bet meter 28. That is, the player can generally depress a “bet one” button (one of the buttons on the player interface panel 30, such as 32), which transfers one credit from the credit meter 27 to the bet meter 28. Each time the button 32 is depressed an additional single credit transfers to the bet meter 28 up to a maximum bet that can be placed on a single play of the electronic gaming device 10. The gaming session may be initiated by pulling the gaming handle 12 or depressing the spin button 33. On some gaming devices 10, a “max bet” button (another one of the buttons 32 on the player interface panel 30) may be depressed to wager the maximum number of credits supported by the gaming device 10 and initiate a gaming session.

If the gaming session does not result in any winning combination, the process of placing a wager may be repeated by the player. Alternatively, the player may cash out any remaining credits on the credit meter 27 by depressing the “cash-out” button (another button 32 on the player interface panel 30), which causes the credits on the credit meter 27 to be paid out in the form of a ticket through the ticket printer 38, or may be paid out in the form of returning coins from a coin hopper (not shown) to a coin return tray.

If instead a winning combination (win) appears on the display 20, the award corresponding to the winning combination is immediately applied to the credit meter 27. For example, if the gaming device 10 is a slot machine, a winning combination of symbols 23 may land on a played payline on reels 22. If any bonus games are initiated, the gaming device 10 may enter into a bonus mode or simply award the player with a bonus amount of credits that are applied to the credit meter 27.

FIGS. 2A to 2C illustrate exemplary types of gaming devices according to embodiments of the invention. FIG. 2A illustrates an example spinning-reel gaming machine 10A, FIG. 2B illustrates an example video slot machine 10B, and FIG. 2C illustrates an example video poker machine 10C.

Referring to FIG. 2A, a spinning-reel gaming machine 10A includes a gaming display 20A having a plurality of mechanical spinning reels 22A. Typically, spinning-reel gaming machines 10A have three to five spinning reels 22A. Each of the spinning reels 22A has multiple symbols 23A that may be separated by blank areas on the spinning reels 22A, although the presence of blank areas typically depends on the number of reels 22A present in the gaming device 10A and the number of different symbols 23A that may appear on the spinning reels 22A. Each of the symbols 22A or blank areas makes up a “stop” on the spinning reel 22A where the reel 22A comes to rest after a spin. Although the spinning reels 22A of various games 10A may have various numbers of stops, many conventional spinning-reel gaming devices 10A have reels 22A with twenty two stops.

During game play, the spinning reels 22A may be controlled by stepper motors (not shown) under the direction of the microprocessor 40 (FIG. 1A). Thus, although the spinning-reel gaming device 10A has mechanical based spinning reels 22A, the movement of the reels themselves is electronically controlled to spin and stop. This electronic control is advantageous because it allows a virtual reel strip to be stored in the memory 41 of the gaming device 10A, where various “virtual stops” are mapped to each physical stop on the physical reel 22A. This mapping allows the gaming device 10A to establish greater awards and bonuses available to the player because of the increased number of possible combinations afforded by the virtual reel strips.

A gaming session on a spinning reel slot machine 10A typically includes the player pressing the “bet-one” button (one of the game buttons 32A) to wager a desired number of credits followed by pulling the gaming handle 12 (FIGS. 1A, 1B) or pressing the spin button 33A to spin the reels 22A. Alternatively, the player may simply press the “max-bet” button (another one of the game buttons 32A) to both wager the maximum number of credits permitted and initiate the spinning of the reels 22A. The spinning reels 22A may all stop at the same time or may individually stop one after another (typically from left to right) to build player anticipation. Because the display 20A usually cannot be physically modified, some spinning reel slot machines 10A include an electronic display screen in the top box 18 (FIG. 1B), a mechanical bonus mechanism in the top box 18, or a secondary display 25 (FIG. 1A) to execute a bonus.

Referring to FIG. 2B, a video gaming machine 10B may include a video display 20B to display virtual spinning reels 22B and various other gaming information 21B. The video display 20B may be a CRT, LCD, plasma screen, or the like. It is usually preferable that the video display 20B be a touchscreen to accept player input. A number of symbols 23A appear on each of the virtual spinning reels 22B. Although FIG. 2B shows five virtual spinning reels 22B, the flexibility of the video display 20B allows for various reel 22B and game configurations. For example, some video slot games 10B spin reels for each individual symbol position (or stop) that appears on the video display 20B. That is, each symbol position on the screen is independent of every other position during the gaming sessions. In these types of games, very large numbers of pay lines or multiple super scatter pays can be utilized since similar symbols could appear at every symbol position on the video display 20B. On the other hand, other video slot games 10B more closely resemble the mechanical spinning reel games where symbols that are vertically adjacent to each other are part of the same continuous virtual spinning reel 22B.

Because the virtual spinning reels 22B, by virtue of being computer implemented, can have almost any number of stops on a reel strip, it is much easier to have a greater variety of displayed outcomes as compared to spinning-reel slot machines 10A (FIG. 2A) that have a fixed number of physical stops on each spinning reel 22A.

With the possible increases in reel 22B numbers and configurations over the mechanical gaming device 10A, video gaming devices 10B often have multiple paylines 24 that may be played. By having more paylines 24 available to play, the player may be more likely to have a winning combination when the reels 22B stop and the gaming session ends. However, since the player typically must wager at least a minimum number of credits to enable each payline 24 to be eligible for winning, the overall odds of winning are not much different, if at all, than if the player is wagering only on a single payline. For example, in a five line game, the player may bet one credit per payline 24 and be eligible for winning symbol combinations that appear on any of the five played paylines 24. This gives a total of five credits wagered and five possible winning paylines 24. If, on the other hand, the player only wagers one credit on one payline 24, but plays five gaming sessions, the odds of winning would be identical as above: five credits wagered and five possible winning paylines 24.

Because the video display 20B can easily modify the image output by the video display 20B, bonuses, such as second screen bonuses are relatively easy to award on the video slot game 10B. That is, if a bonus is triggered during game play, the video display 20B may simply store the resulting screen shot in memory and display a bonus sequence on the video display 20B. After the bonus sequence is completed, the video display 20B may then retrieve the previous screen shot and information from memory, and re-display that image.

Also, as mentioned above, the video display 20B may allow various other game information 21B to be displayed. For example, as shown in FIG. 2B, banner information may be displayed above the spinning reels 22B to inform the player, perhaps, which symbol combination is needed to trigger a bonus. Also, instead of providing a separate credit meter 27 (FIG. 1A) and bet meter 28, the same information can instead be displayed on the video display 20B. In addition, “soft buttons” 29B such as a “spin” button or “help/see pays” button may be built using the touch screen video display 20B. Such customization and ease of changing the image shown on the display 20B adds to the flexibility of the game 10B.

Even with the improved flexibility afforded by the video display 20B, several physical buttons 32B and 33B are usually provided on video slot machines 10B. These buttons may include game buttons 32B that allow a player to choose the number of paylines 24 he or she would like to play and the number of credits wagered on each payline 24. In addition, a max bet button (one of the game buttons 32B) allows a player to place a maximum credit wager on the maximum number of available paylines 24 and initiate a gaming session. A repeat bet or spin button 33B may also be used to initiate each gaming session when the max bet button is not used.

Referring to FIG. 2C, a video poker gaming device 10C may include a video display 20C that is physically similar to the video display 20B shown in FIG. 2B. The video display 20C may show a poker hand of five cards 23C and various other player information 21C including a paytable for various winning hands, as well as a plurality of player selectable soft buttons 29C. The video display 20C may present a poker hand of five cards 23C and various other player information 21C including a number of player selectable soft (touch-screen) buttons 29C and a paytable for various winning hands. Although the embodiment illustrated in FIG. 3C shows only one hand of poker on the video display 20C, various other video poker machines 10C may show several poker hands (multi-hand poker). Typically, video poker machines 10C play “draw” poker in which a player is dealt a hand of five cards, has the opportunity to hold any combination of those five cards, and then draws new cards to replace the discarded ones. All pays are usually given for winning combinations resulting from the final hand, although some video poker games 10C may give bonus credits for certain combinations received on the first hand before the draw. In the example shown in FIG. 2C a player has been dealt two aces, a three, a six, and a nine. The video poker game 10C may provide a bonus or payout for the player having been dealt the pair of aces, even before the player decides what to discard in the draw. Since pairs, three of a kind, etc. are typically needed for wins, a player would likely hold the two aces that have been dealt and draw three cards to replace the three, six, and nine in the hope of receiving additional aces or other cards leading to a winning combination with a higher award amount. After the draw and revealing of the final hand, the video poker game 10C typically awards any credits won to the credit meter.

The player selectable soft buttons 29C appearing on the screen respectively correspond to each card on the video display 20C. These soft buttons 29C allow players to select specific cards on the video display 20C such that the card corresponding to the selected soft button is “held” before the draw. Typically, video poker machines 10C also include physical game buttons 32C that correspond to the cards in the hand and may be selected to hold a corresponding card. A deal/draw button 33C may also be included to initiate a gaming session after credits have been wagered (with a bet button 32C, for example) and to draw any cards not held after the first hand is displayed.

Although examples of a spinning reel slot machine 10A, a video slot machine 10B, and a video poker machine 10C have been illustrated in FIGS. 2A-2C, gaming machines and various other types of gaming devices known in the art are contemplated and are within the scope of the invention.

FIG. 3 is a block diagram illustrating networked gaming devices according to embodiments of the invention. Referring to FIG. 3, multiple electronic gaming devices (EGMs) 70, 71, 72, 73, 74, and 75 may be coupled to one another and coupled to a remote server 80 through a network 50. For ease of understanding, gaming devices or EGMs 70, 71, 72, 73, 74, and 75 are generically referred to as EGMs 70-75. The term EGMs 70-75, however, may refer to any combination of one or more of EGMs 70, 71, 72, 73, 74, and 75. Additionally, the gaming server 80 may be coupled to one or more gaming databases 90. These gaming network 50 connections may allow multiple gaming devices 70-75 to remain in communication with one another during particular gaming modes such as tournament play or remote head-to-head play. Although some of the gaming devices 70-75 coupled on the gaming network 50 may resemble the gaming devices 10, 10A, 10B, and 10C shown in FIGS. 1A-1B and 2A-2C, other coupled gaming devices 70-75 may include differently configured gaming devices. For example, the gaming devices 70-75 may include traditional slot machines 75 directly coupled to the network 50, banks of gaming devices 70 coupled to the network 50, banks of gaming devices 70 coupled to the network through a bank controller 60, wireless handheld gaming machines 72 and cell phones 73 coupled to the gaming network 50 through one or more wireless routers or antennas 61, personal computers 74 coupled to the network 50 through the internet 62, and banks of gaming devices 71 coupled to the network through one or more optical connection lines 64. Additionally, some of the traditional gaming devices 70, 71, and 75 may include electronic gaming tables, multi-station gaming devices, or electronic components operating in conjunction with non-gaming components, such as automatic card readers, chip readers, and chip counters, for example.

Gaming devices 71 coupled over an optical line 64 may be remote gaming devices in a different location or casino. The optical line 64 may be coupled to the gaming network 50 through an electronic to optical signal converter 63 and may be coupled to the gaming devices 71 through an optical to electronic signal converter 65. The banks of gaming devices 70 coupled to the network 50 may be coupled through a bank controller 60 for compatibility purposes, for local organization and control, or for signal buffering purposes. The network 50 may include serial or parallel signal transmission lines and carry data in accordance with data transfer protocols such as Ethernet transmission lines, Rs-232 lines, firewire lines, USB lines, or other communication protocols. Although not shown in FIG. 3, substantially the entire network 50 may be made of fiber optic lines or may be a wireless network utilizing a wireless protocol such as IEEE 802.11 a, b, g, or n, Zigbee, RF protocols, optical transmission, near-field transmission, or the like.

Gaming displays 66, 69 may also be connected to the server 80 through the network 50. These displays 66, 69 may be common gaming displays that show game information relating to multiple gaming devices 70-75, such as linked bonuses, multiple game station outcomes, or the like. Alternatively, the displays 66, 69 may show promotional casino information, advertisements, or other information that is to be communicated to players. The displays may be stand alone displays 66 directly connected to the network 50 or bank displays 69 connected to the network 50 through a bank controller 60.

As mentioned above, each gaming device 70-75 may have an individual processor 40 (FIG. 1A) and memory 41 to run and control game play on the gaming device 70-75, or some of the gaming devices 70-75 may be terminals that are run by a remote server 80 in a server based gaming environment. Server based gaming environments may be advantageous to casinos by allowing fast downloading of particular game types or themes based on casino preference or player selection. Additionally, tournament based games, linked games, and certain game types, such as BINGO or keno may benefit from at least some server 80 based control.

Thus, in some embodiments, the network 50, server 80, and database 90 may be dedicated to communications regarding specific game or tournament play. In other embodiments, however, the network 50, server 80, and database 90 may be part of a player tracking network. For player tracking capabilities, when a player inserts a player tracking card in the card reader 46 (FIG. 1A), the player tracking unit 45 sends player identification information obtained on the card reader 46 through the MCI 42 over the network 50 to the player tracking server 80, where the player identification information is compared to player information records in the player database 90 to provide the player with information regarding their player account or other features at the gaming device 10 where the player is wagering. Additionally, multiple databases 90 and/or servers 80 may be present and coupled to one or more networks 50 to provide a variety of gaming services, such as both game/tournament data and player tracking data.

The various systems described with reference to FIGS. 1-3 can be used in a number of ways. For instance, the systems can be used to track data about various players. The tracked data can be used by the casino to provide additional benefits to players, such as extra bonuses or extra benefits such as bonus games and other benefits as described above. These added benefits further entice the players to play at the casino that provides the benefits.

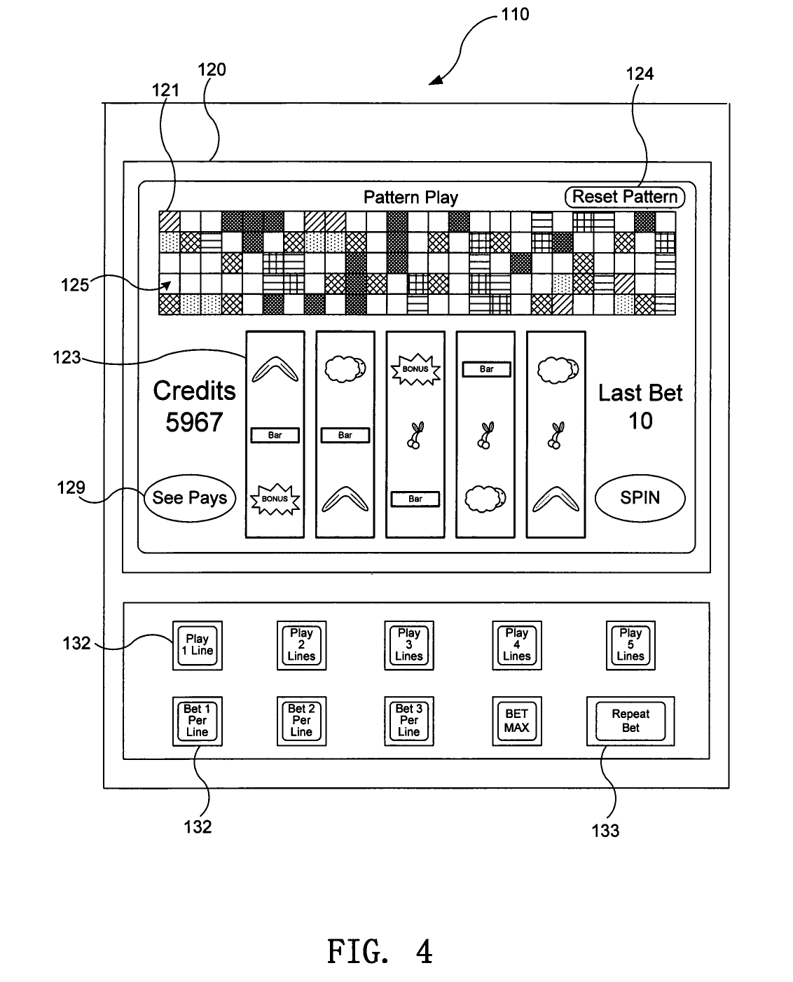

FIG. 4 is a detail diagram of a gaming device having a pattern display according to embodiments of the invention.

Referring to FIG. 4, a gaming device 110 has a gaming display 120 that includes both a game play display 123, 129 and a pattern display 121. As discussed in the above figures, the game play display 123, 129 shows the results of a gaming event played by a player on the gaming device 110 using game buttons 132 and/or a game initiation input device 133. The pattern display 121 is configured to show a conglomeration of shapes, shades, colors, and/or other objects arranged in a bounded area that may lend itself to a show a pattern discernable by a player. That is, the arrangement of objects shown in the pattern display 121 may be interpreted by a player as containing a recognizable pattern that may influence the player to play or not to play the gaming device 110, or to change their wager size, change their betting style, or otherwise influence their behavior. For example, if a player wins a jackpot on a gaming device or has a particularly good string of wins on a gaming device, they may note a pattern shown on the pattern display 121 during this win or string of wins. The player may then associate the noted pattern with good luck, and search out devices with a similar pattern in subsequent visits. Additionally, if a similar pattern becomes evident while the player is playing a gaming device, the player may increase their wager size or bet more frequently because they remember the win or wins they received previously when a similar pattern was displayed, or they may simply believe that the displayed pattern is their lucky pattern. In embodiments where the player can manipulate the pattern, the player may further attempt to manipulate the pattern so that it resembles the previously noted pattern.

Because superstition is frequently associated with gambling activities, players often look for “signs” to determine if a game is lucky or not. However, most game setups (cabinets, glass, signage, coverings, etc.) are consistent due to manufacturing considerations and the difficulty in varying aspects of the gaming hardware. Players may of course feel that one theme or type of gaming device is luckier than another, but choosing between similar gaming device themes or types may be more difficult. The pattern display 121 provides these players a means to differentiate between these gaming devices.

It is human nature to recognize patterns or familiar symbols when presented with an arrangement of objects in apparent disorder. Constellations of stars, recognized fluffy cloud animals, and purported images found in hillsides or pieces or rock are just a few examples of people “finding” something familiar in an arrangement of objects. The pattern display 121 provides a similar “canvas” or medium with which to present a player with an arrangement of objects that may produce a perceivable image, symbol, or other recognizable pattern (collectively referred to as a pattern herein). This arrangement of objects in the pattern display 121 may be modified with each game event or at intervals so that the pattern is not fixed for long periods of time. As the pattern changes, perceived objects may morph, disappear, appear, or otherwise change, which may provide different influences on a current player or other prospective players.

The pattern display 121 may include a presentation of images or a collection of marks created at random or associated with an aspect of a game outcome. To facilitate pattern creation, the pattern display may include a plurality of addresses at which a mark can be assigned. In some embodiments, these marks are randomly assigned by a game RNG or secondary RNG included in the microprocessor 40 (FIG. 1A) of the gaming device 110 to an address or other defined portion of the pattern display. These marks may include a random selection between a plurality of different mark types or mark colors, which may add variety or complexity to the pattern image created by the accumulation of marks. Additionally, if a portion of the pattern display 121 for which a new mark is assigned already includes an existing mark, the new mark may replace the existing mark (i.e., the old mark is removed, and the new mark takes it place), or the existing mark may be modified by the new mark. For example, the existing mark may become darker with the addition of the new mark, the color of the existing mark may be modified by the color of the new mark, the portion where the mark is shown may be divided or apportioned between the two marks, or other image blending techniques may be used to combine the parameters of the two marks. If a pattern display 121 has a threshold number of marks that may be presented at any given time, the placement of a new mark may require the removal of another existing mark. The existing mark to be removed may be identified at random, or may be chosen using an algorithm or set of rules, such as the removal of the mark with the closest proximity to the new mark, removal of the oldest existing mark (FIFO—First In First Out), or removal according to another scheme. The pattern display 121 may be modified (i.e., marks may be generated or modified) at periodic intervals, at random, in response to a game event, or in response to another pattern modification signal.

In other embodiments, patterns may be generated by randomly assigning a mark within a predetermined boundary or range within the pattern display 121 in response to a game outcome or other game event. The predetermined boundary or range may include portions of player selected or otherwise predetermined symbol that is modified by the pattern markings. That is, a symbol or image may be presented in an outlined or other format on the pattern display with identified portions (or address) ranges corresponding to game outcomes. For example, portions of the symbol may be tied to sizes or categories of wins. Top potions of the symbol may be marked when wins over a 100 credits are won, center portions of the symbol may be marked by wins under 100 credits, and bottom portions of the symbol may be marked when a game outcome results in no win for the player. In another example, specific portions of the symbol may be marked when game symbols, cards, or other indicia are received on certain portions of a game display 120. That is, particular reel symbols landing on a visible portion of the game reels (reel position) may trigger a pattern modification signal to generate a mark within a range of addresses (or portion) of the pattern symbol corresponding to the reel position. Although specific addresses of the pattern display 121 may be associated with particular game outcomes, ranges of addresses may preferably be associated with the game outcomes where the specific address of the modification is chosen at random within the address range so that the element of randomness is maintained with the generation of the pattern image on the pattern display 121. In some embodiments, game outcomes may be assigned different weights that generate more or less marks. For example, large wins or bonuses may trigger three marks to be generated and used to modify the pattern display 121, while smaller wins may generate only two or one mark used to modify the pattern display.

The gaming device 110 shown in the embodiment illustrated in FIG. 4 is a video slot machine. While specifics relating to this particular type of gaming device are discussed below with reference to FIG. 4, this inventive concept may be embodied in a wide variety of gaming device types, such as a mechanical spinning reel slot machine (e.g., FIG. 2A), a video poker machine (e.g., FIG. 2C), live-action or electronically controlled table games (e.g., FIG. 2D), internet gaming devices (e.g., FIG. 3), wireless gaming devices, or other types of gaming devices.

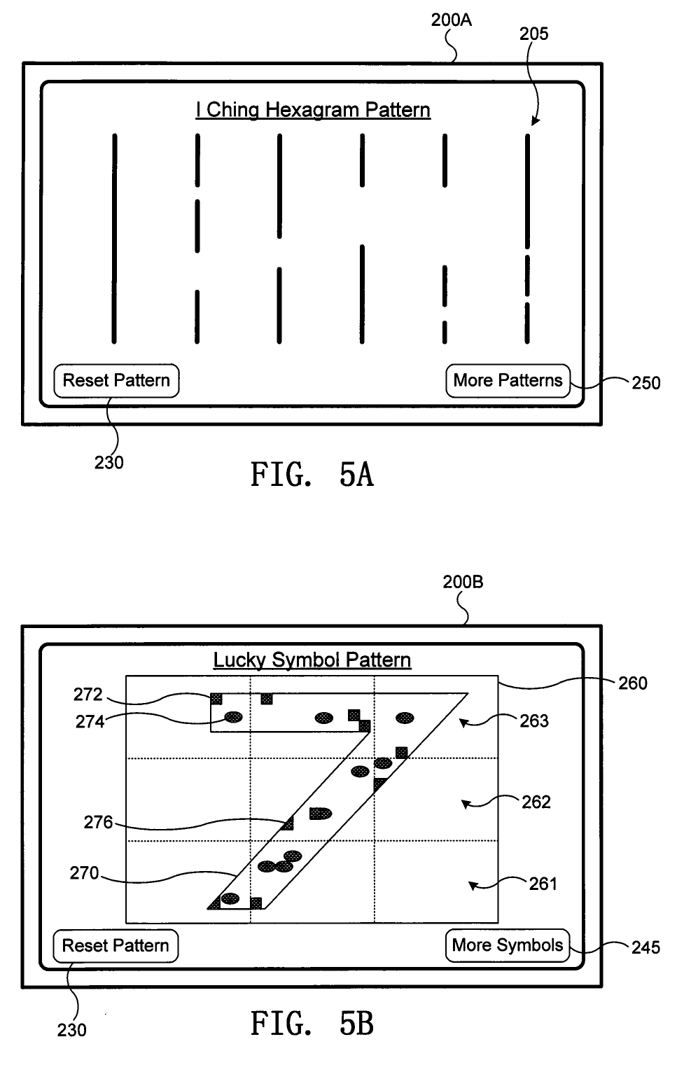

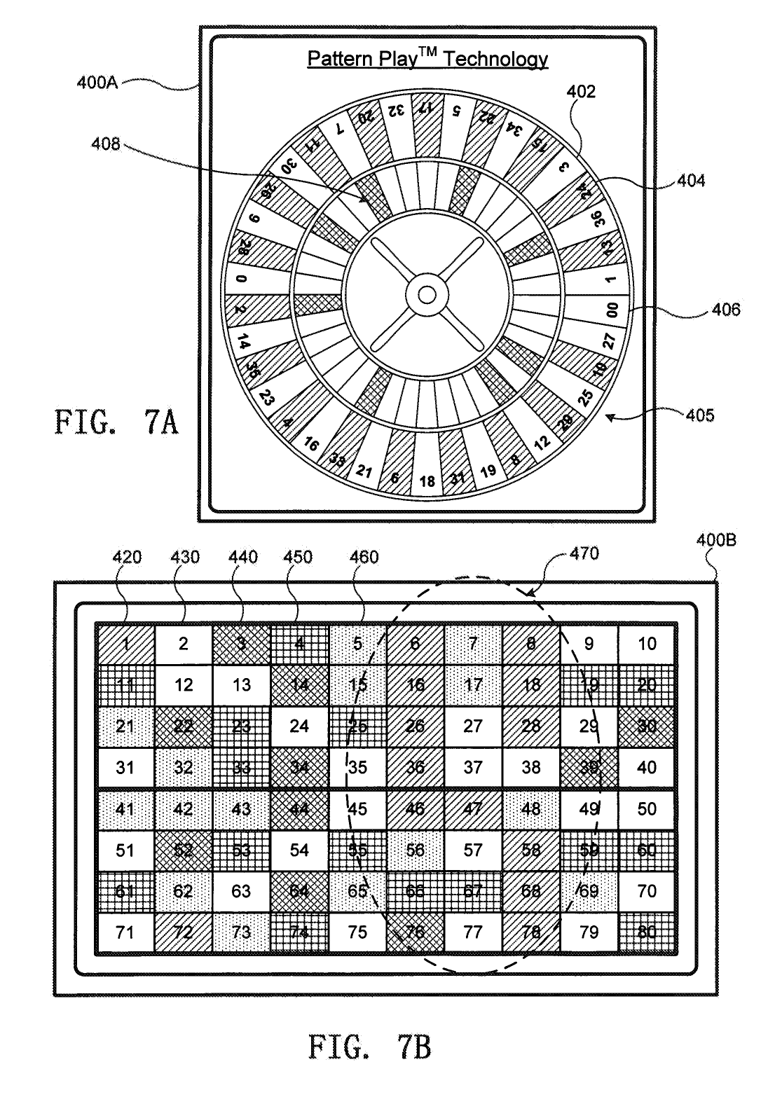

The pattern display 121 shown in this embodiment is matrix (or grid) of box-shaped spaces 125 that may be shaded or colored to display a pattern. However, various other types of patterns may be shown on the pattern display according to game type, player preference, game/casino theme, etc. Various embodiments are illustrated below that show I Ching Hexagram patterns (FIG. 5A), symbol based patterns (FIG. 5B), device-based patterns (FIG. 7A), and map-based patterns (FIG. 7B). However, these are merely examples of types of patterns that may be used. The present inventive concept covers all types of displayed object arrangements that are not related to gaming result based awards. That is, while some embodiments include patterns that may in part be associated with particular parts of a gaming outcome displayed on a game display 120, the pattern created on the pattern display 121 is not directly associated with the game outcome or any value or award associated with the game outcome. For example, while a bonus symbol appearing on a game display 120 may trigger the marking of a particular portion of a pattern display 121, whether or not the bonus symbol is part of a winning award bears no part in the determination of the pattern marking.

To reset the pattern, a player may use the “Reset Pattern” button 124 on the game display 120. Although this button 124 is shown as a soft button in the embodiment illustrated in FIG. 4, the “Reset Pattern” button may be a physical input device or may be linked to one of the game buttons 132. When the Reset Pattern button 124 is activated, a current pattern shown on the pattern display 121 may be altered to show no pattern (i.e., none of the spaces 125 are shaded or colored) or a new pattern. That is, in some embodiments, a pattern reset operation acts to completely remove any pattern on the pattern display 121. With these embodiments, a player may be able to create a new pattern from essentially a blank slate. In other embodiments, a pattern reset operation acts to remove a current pattern and replace it with new randomly generated pattern. With these embodiments, shading and/or coloration remain after the reset operation, but they may not bear any relationship to a currently displayed pattern. This type of operation may be preferable to players that are looking for a new pattern without building one up from a blank display grid.

How the Reset Pattern button operates may be fixed by a game design, or may be determinable by a casino operator or a player. If the gaming device 110 is configured to allow the player to choose the type of reset operation, a player preference for reset operations may be saved in a player account if the player is an indentified player. In some embodiments, the player may choose how the pattern is reset by separate input operations. For example, the player may briefly press the Reset Pattern button 124 to remove a current pattern and generate a new random pattern, or my hold the Reset Pattern button 124 down continuously for three seconds to remove all pattern markings on the pattern display 121. In other example, pressing the Reset Pattern button 124 may bring up a dialog box or window asking the player whether they want to generate a new random pattern or remove all of the pattern markings.

The pattern on the pattern display 121 may also be manipulated or changed by a player in some embodiments. These operations may include manipulating an aspect of the current pattern or selecting a new type of pattern to show on the pattern display. These operations may be carried out by a player input on the pattern display 121 (e.g., touching the pattern display) or may have a separate player button (such as a “More Patterns” button as shown in FIG. 5A) associated with the action.

In embodiments where the pattern display 121 may be manipulated by a player, the player may be able to zoom in (or out) on a portion of the pattern, rotate the pattern, stretch/shrink or crop the pattern, or otherwise change the appearance of the pattern. Alternately, the player may be able to change portions of the patterns, such as altering the shades or colors of a grid space 125 or moving a pattern marking from one grid space to another. Only certain players may be allowed to modify the pattern, such as identified players with a player account or players playing over a minimum average coin-in. Players may also have to “earn” the ability to modify a pattern. That is, a player may have to hit a certain number of symbols or symbol combinations, play for a predetermined amount of time, or meet another set of criteria to earn the ability to modify the pattern. A message may inform the player of this modification ability when it is activated, or the pattern may become highlighted or otherwise activated to bring the player's attention to this feature. A player may want to rearrange a portion of the pattern to better show a desirable symbol or image.

In embodiments where a new type of pattern may be selected for the pattern display 121, the player may be able to choose from a menu of pattern styles or types. This feature may be useful for players that prefer certain types of patterns. As discussed above, and illustrated in some of the following figures, many different types of patterns may be shown on the pattern display 121. When a new pattern is selected, a player may have the option to begin with a blank pattern, or an initial randomly generated pattern. Alternatively, a saved pattern associated with an identified player or game type may be imported and used. Pattern data from the last time a pattern type was selected may also be used in some embodiments.

Referring again to FIG. 4, although the pattern display 121 is shown on the gaming display 120, in other embodiments, the pattern display 121 may be shown on a separate display screen, such as a secondary display 25 (FIG. 1A), a top box display, or a remote display separate from the gaming device 110. If the pattern display 121 is shown on the gaming display 120, it may be shown substantially simultaneously with the game play display 123, 129 (as shown in the embodiment illustrated in FIG. 4). In other embodiments, however, the pattern display 121 may be shown at periodic intervals with other game information, such as a banner or paytable, during game play. The player may also press a gaming button 132, soft button 129, or other player input device to bring up and/or manipulate the pattern display 121. During this request, the pattern display 121 may be displayed along with the game player display 123, 129, or may replace the game play display 123, 129. Additionally, when the game is not in play, the pattern display 121 may be used as part of an attract screen to draw players to the gaming device.

Pattern data used in the pattern display 121 may be maintained in the gaming device memory 41 (FIG. 1A) or maintained in a remote database 90 (FIG. 3) connected to the gaming device via a network 50. Even when the pattern data is maintained in a remote database 90, the local gaming device memory 41 may be used to temporarily store recent modifications to the pattern data. This temporarily stored data may be transferred to the remote database 90 periodically and/or in response to a triggering event, such as a player cashing out or otherwise ending a game session. Here, a remote server 80 (FIG. 3) and a game processor 40 (FIG. 1A) may be used to coordinate and otherwise facilitate this transfer of the pattern data. The server 80 may include a receiver, such as an input port, to receive pattern data recorded and/or stored at the gaming device 110. The server 80 may also include a processor that processes the updated pattern data and generates the visual depiction of the updated pattern data that is to be displayed to the player. A transfer unit may further be included in the server 80 to transfer this visual depiction to the gaming device 110 so that an updated image of the pattern data can be shown on the pattern display 121.

In some embodiments, the ability to provide a pattern display 121 may be downloaded to a gaming device 110 from a remote server 80 (FIG. 3) if requested by a player and/or if the player meets predetermined criteria. That is, a pattern play module may be transferred to a gaming device 110 to provide the gaming device instructions or directives for displaying a pattern display 121 on at least one of the existing displays associated with the gaming device 110. Here, the pattern play module may direct the gaming device to maintain pattern data as well as process and display the pattern data. Alternatively, the pattern play module may direct the game device to periodically transfer recorded pattern data to the server 80 to be processed and returned in a graphical form for display to a player as discussed above. By utilizing pattern play modules, existing gaming devices could be modified to provide a pattern display 121 to players. Pattern play modules may also be an option for a server based gaming environment where players download games to game device terminals.

There are several advantages of maintaining pattern data records on a remote database 90. These advantages include the flexibility of processing pattern data for a particular player over multiple game devices, for particular types of game devices, or even gaming devices spread across related casino properties. Here, the remote pattern data can be accessed by any gaming device that is connected to the remote server 80 and utilized in preparing a pattern display for a player of the gaming device 110.

FIGS. 5A and 5B are detail diagrams of displays showing exemplary types of pattern displays according to embodiments of the invention.

Referring to FIGS. 5A and 5B, pattern displays 200A and 200B are shown with different pattern formats. As discussed above, various styles of pattern data may be presented to a player, which may be dictated by the type of gaming device, the type of pattern requested, and/or the preferences of a particular player. The pattern displays 200A and 200B are shown as individual displays, but they may take any of the forms of the pattern displays discussed above.

The pattern display 200A shown in the embodiment illustrated in FIG. 5A is an I Ching Hexagram pattern display including six line portions 205 having a plurality of dash segments associated with each line. Hexagram patterns typically consist of various dashed lines arranged in six line shapes 205 that correspond to particular meanings derived from an ancient Chinese text. As the line shapes or portions 205 receive additional dashed segments and/or have dashed segments removed, certain hexagram meanings may become apparent. Although a hexagram pattern is shown in this embodiment, trigrams or any other symbol based patterns may be utilized in the pattern display 200A. The dashed segments added or removed may be relatively small so that the hexagram pattern is slowly modified over time. Particular rules may be set up to further associate the patterns with identifiable symbols. For example, a rule may be instituted that no more than three separate line segments may be present in any one line portion 205, even though the dashed segments that are added or removed may be much smaller than any of the separated segments (i.e., the additions or subtractions would typically take place at the end of one of the line segments if three line segments were present in a line portion 205).

One or more player interface devices (e.g., 230 and 250) may also be associated with the pattern display 200A. In this embodiment, the pattern display 200A includes a Reset Pattern button 230 and a More Patterns button 250. The Reset Pattern button 230 may reset the pattern shown on the pattern display 200A, as discussed above. For example, the Reset Pattern button 230 may completely clear the lines 205 of the hexagram, may display only solid completed lines 205, or may display a random pattern of dashes within the lines 205.

The More Patterns button 250 may allow a player to change the type of pattern that is displayed (e.g., change the hexagram pattern shown to a randomly colored grid pattern) or to alter various parameters the pattern display (e.g., the color of the lines 205). That is, by pressing the More Pattern button 250, a player may change the format of the pattern data displayed on the pattern display 200A. The More Pattern button 250 may also be used by the player to save, print, or otherwise memorialize the displayed pattern. For example, if a player wants to save a pattern displayed on a gaming device, the player may use the More Patterns button 250 to access a menu that lets the player save the data to a player loyalty account (if they are a member of player loyalty club), or print the data on a ticket printer (FIG. 1) attached to the gaming device, or another printer that may be attached to the gaming device or remote from the gaming device. The player may even be able to email or text the pattern to a home computer or wireless device.

Referring again to FIG. 5B, the pattern display 200B includes symbol 270 overlaying a grid 260. The goal in this embodiment may be fill in a chosen symbol 270 with shading or coloration. The player may choose (or be assigned) a symbol associated with good luck. The symbol may be presented in an outlined form (as illustrated) to be filled in. However, in other embodiments, the symbol may not include an outline such that it begins transparent and is filled in as the pattern develops. Alternatively, the symbol 270 may initially include some shading or coloration that is replaced or modified as the pattern develops. The grid 260 may correspond to visible symbol positions on a game display of a slot machine. The grid 260 may also correspond to a poker hand (i.e., five sections in the grid), or other gaming device display. Here, the grid 260 corresponds to a three reel slot machine (three vertical columns, each with 3 visible symbol stops). The grid 260 may be used with the symbol 270 to generate a symbol-based pattern.

The grid 260 may be utilized by recognizing particular reel symbols (such as a jackpot or bonus symbol) received on the gaming display and filling in a portion of the symbol 260 that corresponds to the grid section associated with the reel stop position containing the particular reel symbol. For example, if a jackpot symbol was received in the upper position of the third reel, a portion of the symbol 270 in the grid section 263 associated with the reel stop position may be shaded or colored. Likewise, if a jackpot symbol was received in the middle position of the third reel, a portion of the symbol 270 in grid section 262 would be shaded. However, since no part of the symbol 270 falls within grid section 261, a jackpot symbol landing on the bottom position of the third reel may not modify the pattern display 200B.

The type or shape of shading or coloration used to fill in the symbol 270 may be based on a reel symbol received on the game display, may be chosen at random, or may correspond to the portion of the symbol 270 that is selected to be colored/shaded. For example, a shaded box 272, a shaded oval 274, and a shaded triangle 276 may be alternately used, randomly chosen, or assigned to a symbol portion based on the location of the symbol portion. Alternately each of the shading shapes may represent a respective type of outcome received (e.g., the shaded box 272 is used when a jackpot symbol is received, the shaded oval 274 is used when a bonus symbol is received, and the shaded triangle 276 is used when a doubling symbol is received). More or less shading shapes may be used depending upon the desired effects. In additional embodiments, blanks or other symbols received on the reel strips may remove a portion of the shading in a corresponding grid section.

In other embodiments, the grid 260 and the associated functionality may be omitted. In those embodiments, the symbol may just be randomly filled in, or the symbol and a background of the pattern display 200B could both receive shading or coloration. That is, portions of the symbol may not be associated with particular game outcomes. Rather, any portion of the symbol may be filled in or marked at random. Alternatively, both the symbol and the background outside the symbol may be marked. In these embodiments, it may be preferable to assign lighter colors or shades to the background and assign darker colors or shades to the symbol (or the reverse) to contrast and emphasize the symbol.

A More Symbols button 245 may be present to assist the player in selecting a symbol to use with the pattern display 200B. This button 260 may only be available to certain players or may only be available at certain times. If a player is an identified player, the player may be able to upload a desired symbol at a kiosk or over a wireless or Internet connection to their player account. The player may then be able to use the More Symbols button 245 in conjunction with a player identifying device 45 (FIG. 1) to access the uploaded symbol. The More Symbols button 245 may also be used to change the pattern type or perform any of the functionality of the More Patterns button 250 (FIG. 5A) discussed above.

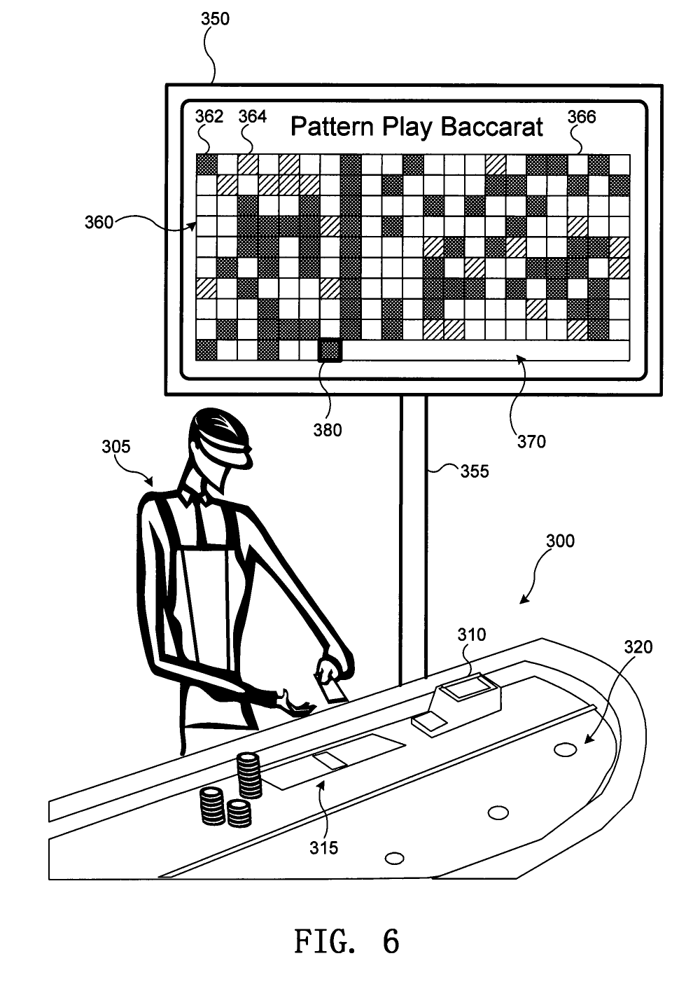

FIG. 6 is a detail diagram of a table gaming device having a pattern display according to embodiments of the invention.

Referring to FIG. 6, a gaming device 300 includes a plurality of player stations 320 and a common pattern display 350 mounted to a support structure 355. In this embodiment, the gaming device 300 is a live action baccarat table with a croupier 305 managing cards from a shoe of cards 310. The live action baccarat table of this embodiment also includes a card reading device 315 that recognizes the cards that are dealt out of the shoe 310. The card reading device 315 may determine when certain events happen on the gaming table, which in turn may impact the timing of the alterations to the pattern display 350 or may act as a recorder of game information so that game results can be tracked for auditing purposes or if the pattern display is to be used in conjunction with a game performance display (not shown). In other embodiments, an overhead camera with card recognition ability may be used independently to record game play on the gaming device 300. If the gaming device is an electronic table, game play may be recorded and tracked by an internal processor.

The pattern display 350 includes a grid (matrix) of spaces 360 that may be shaded or colored to form a pattern. In the embodiment shown in FIG. 6, however, the pattern display 350 is being used to show both the outcome of the game as well as being arranged in a format that may lead to perceivable patterns. Here, the pattern display 360 includes a grid 360 of spaces that represent past outcomes of the baccarat game 300. Black spaces 362 represent banker wins, white spaces 366 represent player wins, and grey spaces 364 represent ties. The spaces may be sequentially filled in left to right and top to bottom. Thus, the black space 362 in the upper left corner may be the oldest game result shown. As rows 370 of spaces fill up with results, new rows are inserted at the bottom of the grid 360, which will shift other exiting rows up and remove a top row if it has reached the upper edge of the grid 360. An indicator 380 may be used to mark the outcome of the last game. Although this pattern display 360 may show outcomes of gaming events on the baccarat table 300, it is arranged in a manner that may also show perceivable patterns, images, symbols, signs, or other recognizable arrangements of objects. For example, a prospective player may believe the pattern display 350 shows a numerical “8,” which has in the past been good luck for them; thus leading the player to play at this baccarat table 300. Another current player at the table may notice that the banker has won every time the eighth column in a row has come up (the next game after indicator 380), and decide to triple his or her normal wager on the banker because they perceive a trend on the pattern display 350.

In other embodiments, however, the pattern shown on the pattern display 360 may include a grid of randomly generated marks, such as the one shown in FIG. 4 and described above, or be any of the other varieties of pattern arrangements described herein. In these embodiments where the pattern display 360 is not associated with game outcomes, the pattern display 360 may alternate with a game performance display (not shown) on the same display structure. The pattern on these pattern displays could be modified at times that are randomly, periodically, or game event determined. Alternately, the croupier 305 or the players may be able to dictate when a modification of the pattern takes place.

The pattern display 350 may be reset at specific times, such as with a croupier change, a shoe reshuffle, at the end of a week, etc. However, since the pattern display 350 includes numerous outcomes that make up the pattern image, it may be preferable to reset the pattern display 350 infrequently. Additionally, although the gaming device shown in this embodiment is a live action baccarat table, game performance displays of a similar nature may be employed for various other table games, such as blackjack, roulette, craps, pai gow, poker, etc.

The gaming table or other gaming device 300 may also include a personalized game display (not shown) associated with a player station or position 320. These personalized game displays may show a copy of the common pattern display 350, an individual player-specific pattern, or game performance information. This configuration may be used with gaming tables that utilize electronic wagering and/or game play, smart tables, gaming machines that include linked bonuses or game play, or any other gaming device that includes multiple player stations 320.

FIGS. 7A and 7B are detail diagrams of exemplary types of displays for displaying patterns according to embodiments of the invention.

Referring to FIG. 7A, a pattern display 400A may include a display of the gaming device to be used with a pattern. In the embodiment shown in FIG. 7A, the gaming device is a roulette game. With many table games, such as roulette, a gaming device may be separated into a wagering portion and a gaming instrument portion. For example, in roulette, the marked table area showing the different wagering options may be the wagering portion and the roulette wheel itself may the gaming instrument portion. The wagering portion is where players place their wagers or bets, while the gaming instrument is utilized to complete a gaming event on the gaming device. A pattern display 400A for the gaming device may show a representation of either the gaming instrument itself, such as the display of the roulette wheel 405 itself in the display 400A shown in FIG. 7A, or may show a representation of the wagering portion (not shown).

This type of pattern display 400A may be desirable if a random pattern can easily be associated with the gaming device. For the illustrated roulette wheel 405, wheel sections 408 associated with physical wheel stops 402, 404, 406 may be shaded or colored to form a pattern. The colors of the red wheel stops 402, black wheel stops 404, and green wheel stops 406 may be shown on the display to accurately represent the physical roulette wheel, but not change as part of the pattern. Rather, inner or outer sections 408 corresponding to the wheel stops 402, 404, 406 may be used to show a pattern. Here, the pattern is not necessarily tied to a particular outcome. That is if a gaming event results in the ball landing in the “3” space 402, the wheel section 408 corresponding to the “3” space may not be changed. If the pattern is randomly generated, no section 408 may be modified due to the occurrence of game result. However, if the occurrence of gaming event result triggers a pattern modification, one or more random sections 408 may be modified.

The coloring or shading of the wheel sections 408 may vary in a manner similar to the pattern shown in FIG. 4, or may be include a uniform color or shade. A player may simply count the number of marked sections 408 to determine if the game is lucky or what the next bet should be, or the pattern might observe a certain pattern in the arrangement of marked sections 408. For example, a player may count eight marked sections 408 and think that “8” is a lucky number so they will place a bet on the gaming device. Alternatively, another player may count eight marked sections 408 and believe that the next number to wager on should be “8.” Still another player may note that the marked sections 408 favor a particular color (like red), a particular part of the wheel, or other possible wagers.

Referring to FIG. 7B, Referring to a keno display screen 400B is shown with a map pattern configuration. The concept of this map shown in FIG. 7B is to overlay a pattern on a game board so that patterns may be identified with actual picks that may be wagered on. That is, the coloration or shading of game spaces 420-460 of the map may cause random patterns, trends, or symbols to appear. For example, a player may see the pattern of a lucky symbol outlined in the map and decide that the game is a lucky game (such as the number “4” as outlined by the dashed oval 470). Alternatively, the player may see a particular grouping that seems to appear frequently on the map display 400B. For example, if it seems that the certain shaded or colored squares are bunched in groups of three, a player may select several groups of three in the next game.

In the embodiment shown in FIG. 7B, space 420 may have a different shade or color than spaces 430, 440, 450, and 460. In coloration terms, space 430 may be a dark blue, space 460 may be light blue, space 420 may be green (neural) or yellow, space 450 may be orange, and space 440 may be red. Using this varied coloration scheme, more subtle patterns may become apparent to a player when a player notes these apparent trends or patterns. Additionally, the pattern may influence a player's next selection of numbers on the game board. The map concept works especially well with games that have a larger number of possible outcomes, such as keno or roulette. However, it can be used with many different types of gaming devices to show patterns associated with a game layout.

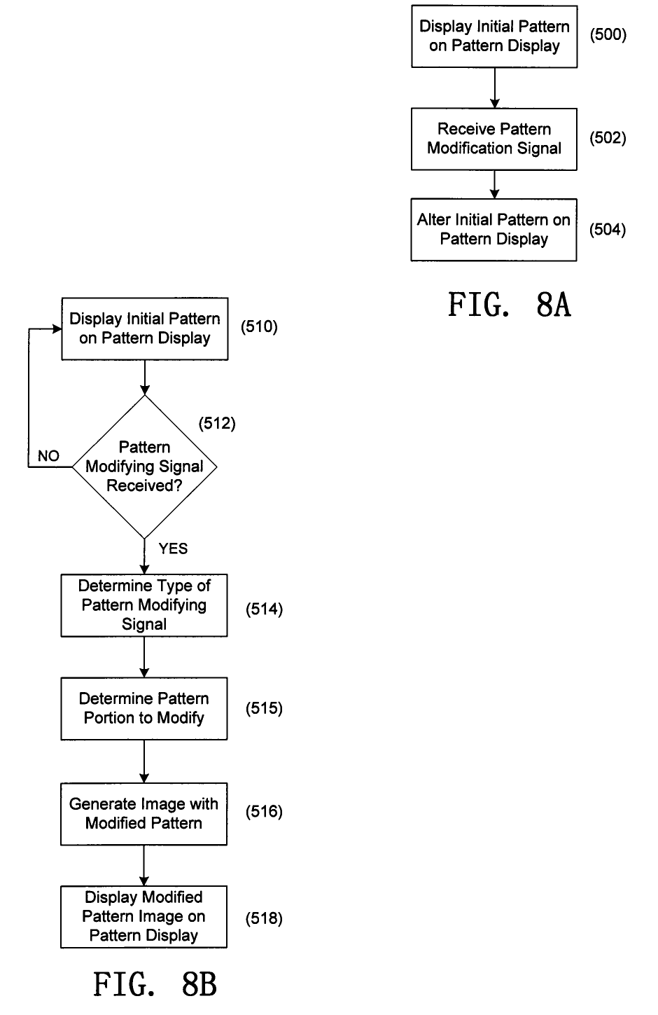

FIGS. 8A and 8B are flow diagrams illustrating methods of generating a pattern display according to embodiments of the invention.

Referring to FIG. 8A, a method of generating a pattern display for a player on a gaming device includes displaying an initial pattern on the pattern display (500) associated with the gaming device, receiving a pattern modifying signal (502), and altering the initial pattern on the pattern display responsive to a pattern altering trigger (504). The pattern on the pattern display may be altered during game play on the gaming device where wagers are received and game outcomes associated with the wagers are determined. In some of these embodiments, the pattern modifying signal may be received in response to the wagers being received, game play being initiated, or game outcomes being determined. However, in other embodiments, the pattern modifying signal may be received in response to periodic triggering event, in response to a random triggering event, or in response to another triggering event. In other embodiments, pattern modifying signals may be received even when game play is not taking place on the gaming device. This may be the result of pattern modifying signals being successively received between game wagers, or simply because the game is not currently being played. Additional details about these processes are discussed below in the embodiments illustrated in FIGS. 8B through 12.

Referring to FIG. 8B, a method of generating a pattern display for a player includes displaying an initial pattern on the pattern display (510) and checking to see if a pattern modifying signal has been received (512). When a pattern modifying signal has been received, a type of pattern modification is determined (514), a portion of the pattern to modify is determined (515), an image of the modified pattern is generated (516), and modified pattern image is displayed on the pattern display (518).

When the initial pattern is displayed (510), the gaming device or gaming system may determine a type of pattern to display, a range of values to use in the display, whether a reset of the pattern has been requested, and what (if any) player-specific requests have been made. The type of pattern modifying signal (514) may influence how a pattern is to be modified. For example, the gaming device or system may determine if a blank portion of the pattern be marked up with shading or color, if another part of the pattern will lose its markings (e.g., where only a certain number of pattern portions may contain markings), or if another modification is requested. The portion of the pattern to modify (515) may be chosen completely at random or may be at least partially influenced by a game outcome, player input, or other metric.

If the pattern data is recorded for later use, the pattern data may be stored temporarily in dynamic or easily updated memory, such as cache memory, DRAM, or flash memories. Alternatively, the pattern data may be stored in a more permanent game memory including magnetic mediums, optical mediums, or flash memory. The recorded pattern data may be stored in local memory at the game device level temporarily or for as long as it exists. If it is stored temporarily, the contents of the local memory may be periodically transmitted to a remote server or other memory database for archival purposes. The local memory may also be erased and cleaned after this periodic transmittal.

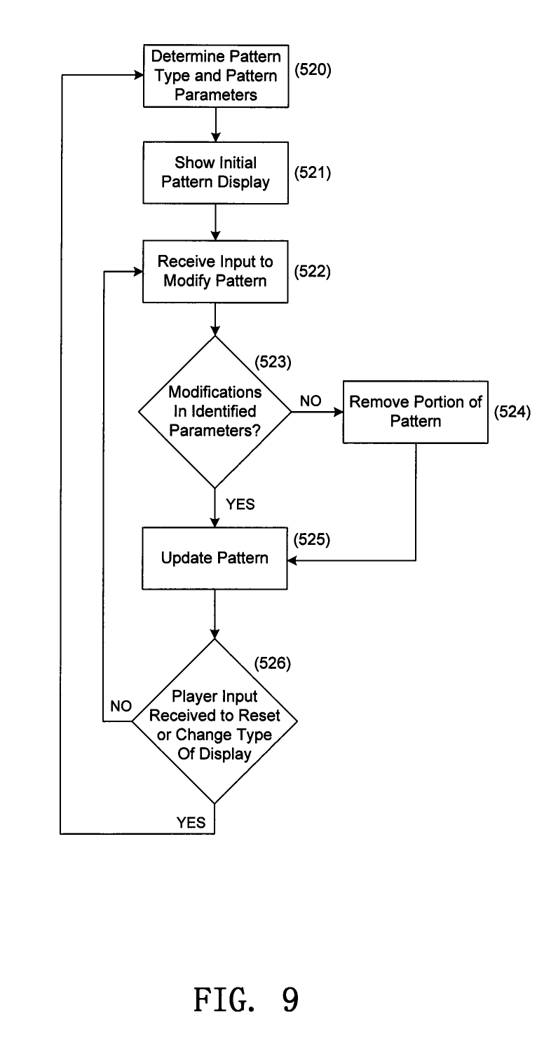

FIG. 9 is a flow diagram illustrating methods of updating a pattern display according to embodiments of the invention.

Referring to FIG. 9, a method of adjusting or refreshing a pattern in a pattern display includes determining a pattern type and parameters of the pattern to be displayed (520). For example, random pattern in a 50 by 10 grid may be requested. After the parameters are determined, an initial pattern conforming to the determined parameters may be displayed (521). In the example above (the random 50 by 10 grid pattern), the initial pattern may simply be blank grid with no shading or coloration, or an initial algorithm may be run to randomly shade, color, or fill-in portions of the pattern display in creating an initial pattern. After an input is received to modify the pattern (522), the gaming device or gaming system may determine if the modification is within the identified parameters associated with the pattern. In the above example, if the pattern parameters specify that only 200 of the 500 spaces in the random pattern grid may be shaded, colored, or filled in at any one time and the pattern currently has 200 shaded spaces, a portion of the pattern may be removed (524) before the specified modification is carried out (525). If on the other hand, only three spaces are currently shaded, the modification would fit in the 200 shaded-space parameter, and the pattern would simply be updated with the modification (525). The modification of the pattern may be randomly chosen (e.g., a space may be chosen at random to be updated with a random color or shade) or may be based in least in part on the type of modification input received.

The gaming device or gaming system then determines if a player input has been received to reset or change the pattern display (526). When no player input is received, the game simply waits until the next input is received to modify the pattern (522). However, when a player directs the gaming device or gaming system to change the display of the pattern, the entire process may be repeated starting with the determination of the pattern type and parameters associated with the pattern (520). In the first discussed example, if the player decides he or she wants to see an I Ching Hexagram instead of the random pattern grid, the pattern type and pattern parameters may be redetermined (520) and a new pattern may be displayed according to the new parameters chosen or associated with the display.

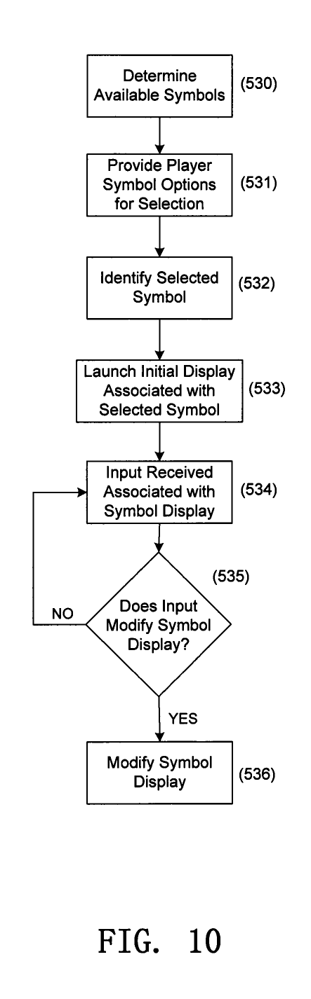

FIG. 10 is a flow diagram illustrating methods of displaying a pattern display according to embodiments of the invention.

Referring to FIG. 10, the method of displaying a pattern display is used to complete a selected symbol, such as is illustrated in FIG. 5B. The method includes determining symbols that are available for selection (530). A list or menu of symbols may be kept on the gaming device or a connected server for use on a pattern display associated with the gaming device. Additionally, a player may be able to import or otherwise upload a symbol to use for the pattern display. The player is then provided with the symbol options for selection (531). Here, the player is presented with the list or menu of possible symbols to use. The player may choose a symbol that they feel is lucky, or one they identify with. In other embodiments, the symbol may be chosen at random by the gaming device or server. The selected symbol is then identified (532) and an initial display is launched with the selected symbol (533). As discussed above, the initial display may include no shading/coloration or may have random portions of it shaded or colored.

The gaming device then waits for an input to be received that is associated with the symbol display (534). After such an input is received, the gaming device determines if the received input modifies the symbol display (535). Referring to FIG. 5B, an input may be received that is associated with a portion of the pattern display 260 that is not covered by the symbol 270. In that instance, the symbol display would not be modified even though an input associated with the display is received. As discussed above, the input may be random or may be triggered by a gaming event or player input. Referring again to FIG. 10, if the gaming device does determine that the received input is associated with a symbol modification, the symbol display is modified (536). Although a portion of a symbol may be designated as having a modification, the exact position of the modification and/or the type of modification may be determined at random.

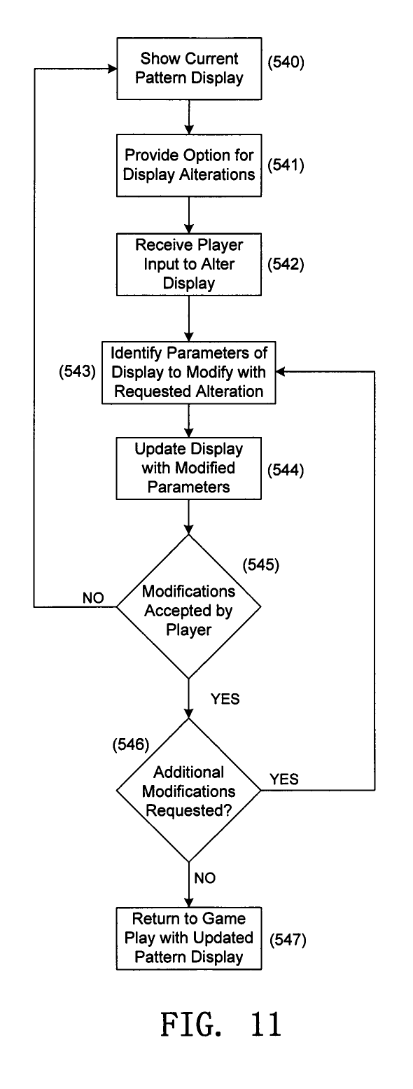

FIG. 11 is a flow diagram illustrating methods of altering a pattern display according to embodiments of the invention.

Referring to FIG. 11, a method of altering a pattern display includes showing a current pattern display (540) along with providing options for altering the display (541). These options may always be available, or may only be periodically available to a player. For example, the options for altering the display (541) may only be available to identified players, be available while a gaming event is not taking place, or be available after a predetermined number of gaming events have been completed. After the alteration options are provided, the gaming device receives a player input to alter the pattern display (542). The parameters of the pattern display are identified so that appropriate ones of the parameters can be properly altered by the requested modification (543). These parameters may include a pattern display type, boundary conditions of the pattern display, shading/coloration schemes currently being used, zooming in on a portion of the pattern, rotating the pattern, etc.

The parameters previously identified are modified as needed to generate an updated pattern display (544). The gaming device may then inquire if the modifications are acceptable to the player. If they are not acceptable, the gaming device may revert back to displaying the current pattern display (540) and restart the process if desired by the player. Alternatively, if the modifications are accepted by the player, the gaming device may inquire if any further modifications are requested (546). If the player wants to make additional modifications to the pattern display, the gaming device may again identify the parameters of the display that are to be modified in response to the modification request (543). If the player is satisfied with the modifications, the gaming device may return to game play with the updated pattern display (547).

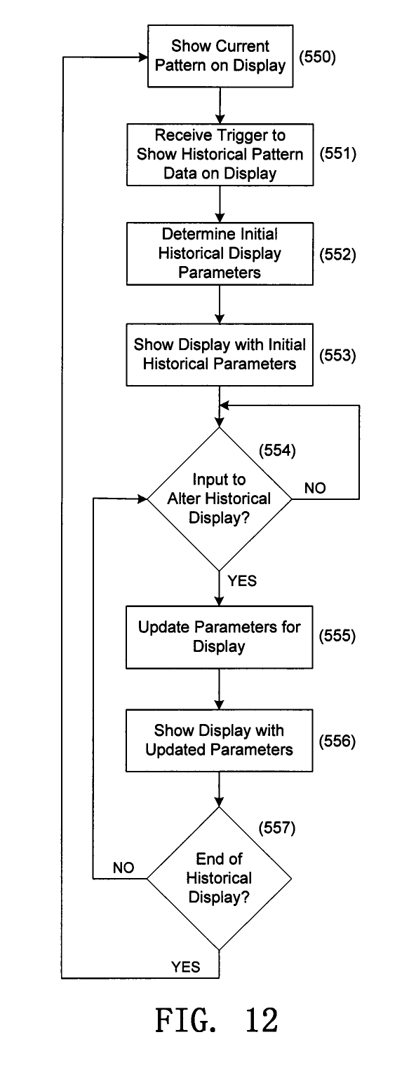

FIG. 12 is a flow diagram illustrating methods of altering a pattern display according to embodiments of the invention.

Referring to FIG. 12, the method of altering a pattern display to show additional historical pattern development includes showing a current pattern on the pattern display (550) and receiving a trigger to show historical pattern data on the game display (551). Unlike the previous embodiment shown in FIG. 11, the player may choose to review how the pattern developed from a past pattern to the current pattern rather than modifying an aspect of the current pattern. Here, an initial starting point including initial historical display parameters are first determined (552). In the example, the initial historical display parameters may be the time based (e.g., how the pattern developed over the last hour), player based (e.g., how has the pattern developed since the present player has been on the gaming device), or event based (e.g., how has the pattern developed since the last jackpot was hit).

Once these historical display parameters are determined (552), the display may be updated to show the historical pattern data with these determined parameters (553). The game device or game system may then determine if an input is received to alter the historical display (554). This input may be in the form of a player pressing a button or otherwise manipulating the display to modify the historical pattern data. Alternatively, the gaming device may automatically modify the historical pattern data by periodically sending a triggering signal to alter the historical display. The player may also exit the historical view of the pattern data to return to a current display of the pattern.

When this input is received, the parameters for the display are updated (555). In one example, where the device is instructed to automatically modify the pattern data associated with the current player, a trigger may be received every 10^{th} of a second to modify the initially displayed historical pattern as the pattern was modified during game play. Thus, a trigger is received after the first 10^{th} of a second (0.1 seconds) and the parameters for the historical display are changed to display the pattern after its first modification. After these parameters are determined (555), the display itself is updated and shown with the pattern data associated with the newly determined parameters (556). The game device or system then determines if the end of the historical display has been reached (557). In the ongoing example, the automatically changing historical pattern display continues until the current pattern display is reached, or the player otherwise ends the historical display.

Some embodiments of the invention have been described above, and in addition, some specific details are shown for purposes of illustrating the inventive principles. However, numerous other arrangements may be devised in accordance with the inventive principles of this patent disclosure. Further, well known processes have not been described in detail in order not to obscure the invention. Thus, while the invention is described in conjunction with the specific embodiments illustrated in the drawings, it is not limited to these embodiments or drawings. Rather, the invention is intended to cover alternatives, modifications, and equivalents that come within the scope and spirit of the inventive principles set out in the appended claims.

1. A method of displaying a pattern associated with a gaming device, the method comprising:
receiving player inputs to place wagers on gaming events on the gaming device;
displaying gaming outcomes of the gaming events on the gaming device;
displaying an initial pattern; and
altering the initial pattern as play on the gaming device progresses.

2. The method of claim 1, wherein the initial pattern is altered in response to a player input on the gaming device.

3. The method of claim 2, wherein the player input is an input corresponding to an operation of the gaming event.

4. The method of claim 1, wherein the initial pattern is altered in response to an outcome of a gaming event.

5. The method of claim 1, wherein the initial pattern is altered independently of the progressing game play.

6. The method of claim 1, wherein the initial pattern is selectable by the player.

7. The method of claim 1, wherein the initial pattern is displayed separately from the display of the gaming events.

8. A method of displaying an image to a player of a gaming device, the method comprising:
displaying an initial image;
receiving an image modifying signal;
determining a portion of the initial image to modify in response to the image modifying signal;
generating a modified image; and
displaying the modified image to the player.

9. The method of claim 8, wherein the initial image is a display of a plurality of spaces, and wherein at least one of the plurality of spaces is randomly shaded in response to the image modifying signal.

10. The method of claim 8, wherein the image is a visual representation of a portion of the gaming device with modifiable portions.

11. The method of claim 10, wherein the modifiable portions are associated with a location of a gaming event outcome.

12. The method of claim 8, wherein displaying an initial image includes receiving a symbol selection.

13. The method of claim 12, wherein the symbol selection is received in response to a player input.

14. The method of claim 12, wherein the symbol is initially shown in an outline format, and wherein the symbol is modified by having a mark assigned to a portion of the symbol within the symbol outline.

15. The method of claim 8, wherein the image modifying signal is received independent of game play on the gaming device.

16. The method of claim 8, wherein the image modifying signal is received after a game event outcome is determined.

17. The method of claim 8, wherein the portion of the initial image to modify is determined entirely at random.

18. The method of claim 8, wherein the portion of the initial image to modify is determined by a location of a symbol on a game display of the gaming device.

19. The method of claim 8, further comprising receiving an image-type selection from the player prior to displaying the initial image.

20. The method of claim 8, wherein the image modifying signal is received periodically.

21. A gaming device comprising:
a player gaming station to allow a player to place a wager on a gaming event;
a pattern display configured to display an image independent of awards associated with the game event; and
a processor configured to modify the image in response to an image modifying signal.

22. The gaming device of claim 21, further comprising a game display to display an outcome of the gaming event.

23. The gaming device of claim 21, wherein the pattern display is a common display for a plurality of gaming devices.

24. The gaming device of claim 21, wherein the gaming device is a table game having a plurality of player gaming stations.

25. The gaming device of claim 21, further including a pattern reset button configured to reset the image displayed on the pattern display.

26. The gaming device of claim 21, further including a player input device configured to allow the player to manipulate the image displayed on the pattern display.

27. The gaming device of claim 26, wherein the player input device is configured to display a historical progression of the image displayed on the pattern display from a historical image to a current image.

28. A gaming system for displaying a visual pattern associated with at least one gaming device, the system comprising:
a memory to store pattern data associated with an initial pattern image;
a processor configured to modify the pattern data in response to an image modifying signal and generate a modified pattern image; and
a pattern display operatively connected to the processor configured to display the modified pattern image generated by the processor.

29. The gaming system of claim 28, wherein the pattern display is included in the gaming device.

30. The gaming system of claim 29, wherein the processor is included in a server connected to the gaming device through a network.

31. The gaming system of claim 30, wherein the memory is included in a database associated with the server.

32. The gaming system of claim 31, wherein the pattern display is further configured to download and display the modified pattern in response to a player request.

33. A method of displaying an image to a player of a gaming device, the method comprising:
displaying an image;
receiving a first gaming outcome on the gaming device;
modifying a first portion of the image with a first pattern mark in response to the first gaming outcome;
displaying the image with the modified first portion to the player;
receiving a second gaming outcome on the gaming device;
modifying a second portion of the image with a second pattern mark in response to the second gaming outcome, wherein the second portion of the image is sequentially related to the first portion of the image; and
displaying the image with the modified first and second portions to the player.

34. The method of claim 33, wherein the first pattern mark and second pattern mark are determined at random.

35. The method of claim 33, wherein the first pattern mark and second pattern mark are determined based on the first gaming outcome and second gaming outcome, respectively.

36. The method of claim 33, wherein the first pattern mark and second pattern mark are directly adjacent.

37. The method of claim 33, wherein modifying a second portion of the image includes removing a third portion of the image.

38. The method of claim 37, wherein the third portion of the image includes a third pattern mark generated in response to a third gaming outcome received prior to the first and second game outcomes.
